(19) United States
(12) Patent Application Publication
(10) Pub. No.: US 2022/0142115 A1
(43) Pub. Date: May 12, 2022

(54) ANIMAL LITTERS WITH REDUCED DUSTING

(71) Applicant: Church & Dwight Co., Inc., Princeton, NJ (US)

(72) Inventor: Steven T. Adamy, Lawrenceville, NJ (US)

(73) Assignee: Church & Dwight Co., Inc., Princeton, NJ (US)

(21) Appl. No.: 17/433,643

(22) PCT Filed: Feb. 25, 2020
(86) PCT No.: PCT/IB20/51610

§ 371 Date: Aug. 25, 2021

Related U.S. Application Data
(60) Provisional application No. 62/810,479, filed on Feb. 26, 2019.

(51) Int. Cl. A01K 1/015; B01J 20/10; B01J 20/14; B01J 20/26; B01J 20/32

(52) U.S. Cl. CPC A01K 1/0155; A01K 1/0154; B01J 20/103; B01J 20/14; B01J 20/3295; B01J 20/3204; B01J 20/3212; B01J 20/3234; B01J 20/262

(57) ABSTRACT

An animal litter composition having enhanced dust reduction properties, and a related method, are disclosed. The animal litter can include a plurality of particles a liquid adsorbing material, such as diatomaceous earth. The animal litter can also include a dust reducing composition, which composition particularly can comprise polyvinyl alcohol and nanoparticulate silica.

### FIELD OF THE DISCLOSURE

The present disclosure relates to an adsorbent composition and its method of production, as well as its use as an animal litter. More particularly, the adsorbent composition is configured to exhibit reduced dusting.

### BACKGROUND

Various types of litters have been used for many years in the area of pet care to provide a dedicated location for housebroken animals, such as cats, to urinate and defecate indoors. Litters generally can be formed of a liquid-absorbing material, such as clay, to provide for efficient absorption of urine. Litters further can include a variety of added materials, such as clumping aids, fragrances, and the like. The most commonly used litter box liquid-absorbing materials are inexpensive clays, such as calcined clays, that are safe and non-irritating to the animals, and that absorb substantial amounts of liquids. Other porous, solid litter box absorbent materials, that are used alone or in combination, include diatomaceous earth, straw, sawdust, wood chips, wood shavings, porous polymeric beads, shredded paper, sand, bark, cloth, ground corn husks, and cellulose.

Many materials used in pet litters can have a significantly high dust content. Any motion that causes movement of the litter, including filling of a litter container, scooping of the litter, or a pet's movement in the litter, can cause a release of the dust into the atmosphere—i.e., so-called “dusting.” This can be undesirable in relation to cleanliness of the household in which a litter pan may be located and also in relation to avoiding nasal and/or pulmonary irritation by the released dust. Accordingly, there remains a need for improved animal litters that particularly exhibit reduced dusting while still remaining a lightweight and easy to dispose of litter.

### SUMMARY OF THE DISCLOSURE

The present disclosure relates to animal litter compositions. The animal litter compositions can be particularly configured to provide reduced dusting during movement of the loose litter. In some embodiments, the animal litter composition comprises a plurality of liquid-absorbing particles. Preferably, the liquid-absorbing particles are also configured to provide reduced weight relative to other liquid-absorbing particles. As such, in some embodiments, the liquid absorbing particles can comprise, consist essentially of, or consist of particles of diatomaceous earth. The liquid-absorbing particles can be combined with a dust-reducing composition, which dust-reducing composition preferably is formed of a combination of materials. In some embodiments, the dust-reducing composition can comprise, consist essentially of, or consist of polyvinyl alcohol (PVOH) and nanoparticulate silica. In further embodiments, the dust-reducing composition can comprise one or more polymers, such as PVOH, polyvinyl acetate, polyvinyl pyrrolidone, polyethylene oxide, polyacrylic acid, poly lactate, and copolymers of any of the foregoing. Preferably any polymers used in this regard exhibit a moderate to high degree of hygroscopicity.

In one or more embodiments, the present disclosure relates to an animal litter composition comprising: a plurality of particles of diatomaceous earth; polyvinyl alcohol (PVOH); and a nanoparticulate silica material. The animal litter composition can be further defined in relation to any one or more of the following statements, which may be combined in any number or order.

The plurality of particles of the diatomaceous earth can have an average particle size of about 0.2 mm to about 5 mm.

The PVOH can have a degree of hydrolysis of about 87% to about 89%.

The PVOH can have a weight average molecular weight of about 20,000 g/mol or greater.

The PVOH can have a weight average molecular weight of about 20,000 g/mol to about 75,000 g/mol.

The nanoparticulate silica can have an average particle size of about 50 nm or less.

The nanoparticulate silica can have an average particle size of about 5 nm to about 25 nm.

The nanoparticulate silica can be cationic.

The nanoparticulate silica can be a colloidal silica.

One or both of the PVOH and the nanoparticulate silica material can be present as a coating on at least a portion of an outer surface of the plurality of particles of the diatomaceous earth.

The PVOH can be present in an amount of about 0.5% to about 5% by weight based on the total weight of the animal litter composition.

The nanoparticulate silica can be present in an amount of about 0.5% to about 5% by weight based on the total weight of the animal litter composition

In one or more embodiments, the present disclosure can relate to a method for producing an animal litter composition, the method comprising: providing a plurality of particles of diatomaceous earth; mixing the plurality of particles of diatomaceous earth with an aqueous dispersion of nanoparticulate colloidal silica and an aqueous solution of polyvinyl alcohol (PVOH) to form a mixture; and drying the mixture to form the animal litter composition. The method can be further defined in relation to any one or more of the following statements, which may be combined in any number or order.

The plurality of particles of the diatomaceous earth can have an average particle size of about 0.2 mm to about 5 mm.

The PVOH can have a degree of hydrolysis of about 80% to about 99% and a weight average molecular weight of about 20,000 g/mol to about 75,000 g/mol.

The nanoparticulate silica can have an average particle size of about 5 nm to about 25 nm.

The nanoparticulate colloidal silica can be cationic.

The mixing can be effective to provide one or both of the PVOH and the nanoparticulate colloidal silica as a coating on at least a portion of an outer surface of the plurality of particles of the diatomaceous earth.

The plurality of particles of the diatomaceous earth can be mixed with a sufficient amount of the aqueous solution of the PVOH such that the resulting animal litter composition comprises about 0.5% to about 5% by weight of the PVOH based on the total weight of the animal litter composition.

The plurality of particles of the diatomaceous earth can be mixed with a sufficient amount of the aqueous dispersion of the nanoparticulate colloidal silica such that the resulting animal litter composition comprises about 0.5% to about 5% by weight of the nanoparticulate colloidal silica based on the total weight of the animal litter composition.

### BRIEF DESCRIPTION OF THE DRAWINGS

Having thus described the disclosure in general terms, reference will now be made to the accompanying drawings, which are not necessarily drawn to scale, and wherein:

FIG. 1 is a contour plot of total dust particle counts measured after pouring an animal litter composition according to example embodiments of the present disclosure into a graduated cylinder, the contours being plotted on the basis of the dry weight percentage of PVOH to the dry weight percentage of nanosilica used in the litter composition;

FIG. 2 is a contour plot of a fraction of dust in treated diatomaceous earth particles compared to non-treated diatomaceous earth particles measured after pouring an animal litter composition according to example embodiments of the present disclosure into a graduated cylinder, the contours being plotted on the basis of the dry weight percentage of PVOH to the dry weight percentage of nanosilica used in the litter composition;

FIG. 3 is graph of a dust fraction versus a ratio of PVOH to nanosilica for various levels of nanosilica used in preparing animal litter compositions according to embodiments of the present disclosure; and

FIG. 4 is the contour plot shown in FIG. 2 including data points for samples used in opacity testing.

### DETAILED DESCRIPTION OF THE DISCLOSURE

The present disclosure now will be described more fully hereinafter with reference to specific embodiments and particularly to the various drawings provided herewith. Indeed, the disclosure may be embodied in many different forms and should not be construed as limited to the embodiments set forth herein; rather, these embodiments are provided so that this disclosure will satisfy applicable legal requirements. As used in the specification, and in the appended claims, the singular forms “a,” “an,” “the,” include plural referents unless the context clearly dictates otherwise.

The present disclosure relates to an animal litter composition exhibiting reduced dusting. The animal litter composition can comprise a base material forming a majority of the composition based on the total weight thereof. The base material may be a liquid absorbing and/or an odor absorbing material. A clay-based material and/or a zeolite-based material may be useful in forming at least a portion of the base material. In some embodiments, diatomaceous earth particularly may be used as the base material. In particular, the base material may be formed substantially or completely from diatomaceous earth. As such, the base material expressly may exclude a clay-based material and/or a zeolite-based material. In one or more embodiments, the base material (e.g., diatomaceous earth) can be present in the litter composition in an amount of about 25% by weight or greater, about 50% by weight or greater, about 75% by weight or greater, or about 90% by weight or greater, such as up to a maximum of about 99% by weight. In particular, the base material (e.g., diatomaceous earth) can be present in the litter composition in an amount of about 50% to about 99%, about 70% to about 98%, or about 85% to about 97% by weight, all of the foregoing weights being based on the total weight of the litter composition.

The base material, and specifically diatomaceous earth that is used as the base material, can be present as a plurality of particles. In some embodiments, performance can be improved though use of a base material exhibiting a defined particle size range. For example, suitable base materials (e.g., diatomaceous earth) can be provided with an average particle size of about 0.2 mm to about 5 mm, about 0.3 mm to about 4 mm, about 0.5 mm to about 3 mm, or about 0.5 mm to about 1.5 mm. Particle size can be evaluated utilizing any known method. For example, the base material particles can be sieved to a defined size range using an ANSI standard sieve. In some embodiments, suitable materials can be those sized to pass through an ANSI size 16 sieve while being retained on an ANSI size 36 sieve.

In some embodiments, the surface area of each particle of the base material may comprise a defined surface area that can be useful for preferred combination of the dust reducing materials that are further described herein and/or for providing improved adsorption of liquids and/or odors. For example, particles of the base material can have an average surface area that is less than 20 m²/g, less than 15 m²/g, or less than 10 m²/g. In each of the foregoing ranges, it is understood that the particles preferably have a minimum surface area of at least 1 m²/g. In some embodiments, the particles of the base material can have an average surface of about 1 m²/g to about 20 m²/g, about 2 m²/g to about 15 m²/g, or about 3 m²/g to about 10 m²/g. Surface area can be measured utilizing known methods, such as the Brunauer, Emmett, Teller (“BET”) method wherein surface area is calculated using N₂ absorption. The above values, in some embodiments, thus may be referred to as the BET surface area.

In addition to the base material, animal litter compositions as described herein can comprise a combination of materials that are configured to provide reduced dusting of the base material. In particular, although diatomaceous earth is particularly useful in providing a litter composition that is relatively lightweight compared to typical, clay-based compositions, the diatomaceous earth may exhibit an undesirably high amount of dusting. The anti-dusting materials used herein can be particularly useful to control dusting of a high dust base material, such as diatomaceous earth. The anti-dusting effect can be especially pronounced when the materials are used in combination.

In one or more embodiments, a suitable anti-dusting material can be a polymeric material and, preferably, a polymeric material exhibiting a moderate to a high degree of hygroscopicity. For example, the dust-reducing composition can comprise one or more polymers, such as PVOH, polyvinyl acetate, polyvinyl pyrrolidone, polyethylene oxide, polyacrylic acid, poly lactate, and copolymers of any of the foregoing.

In some embodiments, an anti-dusting material for use herein specifically can comprise PVOH. Typically, PVOH is produced by a two-step process wherein vinyl acetate is first polymerized into polyvinyl acetate (PVA), which polymerization step is followed by hydrolysis or alcoholysis of PVA into a copolymer of vinyl acetate and vinyl alcohol—i.e., the so-formed polyvinyl alcohol (PVOH). Depending on the hydrolysis level, a wide range of PVOH copolymers can be produced when the hydrolysis reaction is allowed to reach certain conversion levels. For PVOH, the degree of hydrolysis is controlled during the alcoholysis reaction and is independent of the control of the molecular weight of the PVOH formed. Fully hydrolyzed PVOH is obtained if alcoholysis is allowed to go to completion. The reaction is terminated by removing or neutralizing the sodium hydroxide catalyst used in the process. Typically, a small amount of water is added to the reaction vessel to promote the saponification reaction of PVA. The extent of hydrolysis is inversely proportional to the amount of water added. The PVOH product is typically washed with methanol, filtered, and dried to form a white, granular powder. The molecular weight of the PVOH is controlled by the polymerization condition of vinyl acetate. Due to the strong dependence of PVOH on the molecular weight and degree of hydrolysis, PVOH is typically supplied in combination of these two parameters. PVOH is classified into 1) partially hydrolyzed (87.0 to 89.0% hydrolysis); 2) intermediately hydrolyzed (95.5 to 96.5% hydrolysis); 3) fully hydrolyzed (98.0 to 98.8% hydrolysis); and 4) super hydrolyzed (>99.3% hydrolysis).

In some embodiments, the PVOH can have a molecular weight (or molecular mass) within a desired range. Molecular mass can be expressed as a weight average molecular mass (M_{w}) or a number average molecular mass (Mₙ). Both expressions are based upon the characterization of macromolecular solute containing solution as having an average number of molecules (nᵢ) and a molar mass for each molecule (Mᵢ). Accordingly, number average molecular mass is defined by formula 1 below.

$${M}_{n} = \frac{\sum {n}_{j} {M}_{i}}{\sum {n}_{j}} \qquad ( 1 )$$

Weight average molecular mass (also known as molecular mass average) is directly measurable using light scattering methods and is defined by formula 2 below.

$$\text{?} = \frac{\sum {n}_{i} {M}_{i}^{2}}{\sum {n}_{i} {M}_{i}} \\ \text{?} \text{indicates text missing or illegible when filed} \qquad ( 2 )$$

Molecular mass can also be expressed as a Z-average molar mass (M_{z}), wherein the calculation places greater emphasis on molecules with large molar masses. Z-average molar mass is defined by formula 3 below.

$$\text{?} = \frac{\sum {n}_{i} {M}_{i}^{3}}{\sum {n}_{i} {M}_{i}^{2}} \\ \text{?} \text{indicates text missing or illegible when filed} \qquad ( 3 )$$

Unless otherwise noted, molecular mass is expressed herein as weight average molecular mass (or weight average molecular weight). In one or more embodiments, the PVOH utilized herein can have a weight average molecular weight of about 15,000 g/mol or greater, about 20,000 g/mol or greater, or about 25,000 g/mol or greater, such has having an upper limit of about 500,000 g/mol. In further embodiments, the PVOH can have a weight average molecular weight of about 15,000 g/mol to about 250,000 g/mol, about 15,000 g/mol to about 150,000 g/mol, about 15,000 g/mol to about 100,000 g/mol, about 20,000 g/mol to about 75,000 g/mol, or about 25,000 g/mol to about 60,000 g/mol.

The PVOH can be particularly useful to provide anti-dusting properties to the base composition (especially diatomaceous earth) when the PVOH is present within a defined range. For example, the PVOH preferably can be present in an amount of about 0.2% or greater, about 0.5% or greater, or about 1% or greater by weight (e.g., with an upper limit of about 10% by weight), based on the total weight of the litter composition. More particularly, the PVOH can be present in an amount of about 0.5% to about 5%, about 1% to about 4.5%, or about 1.5% to about 4% by weight based on the total weight of the animal litter composition.

The ability of the PVOH to function as an anti-dusting agent can be increased through combination with a further anti-dusting agent, particularly a nanoparticulate silica material. The silica preferably is substantially pure—e.g., comprising less than 5% by weight, less than 2% by weight, less than 1% by weight, or less than 0.5% by weight of impurities. In some embodiments, the nanoparticulate silica can be colloidal silica. If desired, the nanoparticulate silica, particularly a colloidal silica, can be provided as a dispersion or a slurry for mixture with the plurality of particles of diatomaceous earth. The dispersion or slurry can be in an aqueous medium. Nanoparticulate silica may be anionic, cationic, or nonionic. In preferred embodiments, the nanoparticulate silica used in the present compositions is cationic. Several different types of nanoparticulate silica may be suitable according to the present disclosure. For example, nanoparticulate silica such as LUDOX® TM 40, LUDOX® AM, LUDOX® CL, LUDOX® AS-40, LUDOX® CL-X, LUDOX® TMA, LUDOX® SM, and LUDOX®HS30, which are all commercially available from W.R. Grace & Co., Columbia Md., and the like, may be suitable. The type of nanoparticulate silicas that are suitable for the present disclosure particularly may have a specific counterion and/or approximate particle size of the nanoparticulate silica selected. The counterion or ion that accompanies an ionic species in order to maintain electric neutrality may be characterized based on the interaction of the nanoparticulate silica with the PVOH and/or the diatomaceous earth. Therefore, the type of nanoparticulate silica selected preferably may be a nanoparticulate silica that is overall cationic, a nanosilicate having a Na⁺ counterion, a nanosilicate having a NH₄⁺ counterion, or a deionized nanosilicate.

The nanoparticulate silica (which may also be referred to herein as nanosilica) can be provided as a plurality of particles having a particular average size. For example, the nanoparticulate silica can have an average particle size of about 50 nm or less, about 40 nm or less, about 30 nm or less, or about 20 nm or less (e.g., with a minimum average size of about 2 nm). In some embodiments, the nanoparticulate silica can have an average particle size of about 2 nm to about 50 nm, 3 nm to about 40 nm, about 4 nm to about 30 nm, or about 5 nm to about 25 nm.

The nanoparticulate silica can be particularly useful to provide anti-dusting properties to the base composition (especially diatomaceous earth) when the nanoparticulate silica is present within a defined range. For example, the nanoparticulate silica preferably can be present in an amount of about 0.2% or greater, about 0.5% or greater, or about 1% or greater by weight (e.g., with an upper limit of about 10% by weight), based on the total weight of the litter composition. More particularly, the nanoparticulate silica can be present in an amount of about 0.5% to about 5%, about 1% to about 4.5%, or about 1.5% to about 4% by weight based on the total weight of the animal litter composition.

The anti-dusting agents, such as PVOH and nanoparticulate silica can be combined with the diatomaceous earth to provide a variety of types of combinations. In some embodiments, one or both of the PVOH and the nanoparticulate silica material can be combined with the diatomaceous earth so as to be present as a coating on at least a portion of an outer surface of the plurality of particles of the diatomaceous earth. In some embodiments, however, one or both of the PVOH and the nanoparticulate silica can be present in a simple mixture with the diatomaceous earth.

In addition to the components noted above, the animal litter compositions can comprise a variety of additional components as desired, such as fillers, fragrance, clump aids, and the like. In some embodiments, the animal litter compositions, however, can consist of or consist essentially of diatomaceous earth, PVOH, and nanoparticulate silica.

In some embodiments, the present animal litter compositions can include one or more filler materials, such as non-absorbent, non-soluble substrates and/or absorbent substrates. In one or more embodiments, useful fillers can include absorbent substrates, such as non-clumping clays. Non-limiting examples of useful non-clumping clays include attapulgite, Fuller's earth, calcium bentonite, palygorskite, sepiolite, kaolinite, illite, halloysite, hormite, vermiculite or mixtures thereof. Suitable fillers according to the present disclosure also can include a variety of non-absorbent, non-soluble substrates, such as non-clay substances. Non-limiting examples of non-clay materials that can be used include zeolites, crushed stone (e.g., dolomite and limestone), gypsum, sand, calcite, recycled waste materials, and silica (e.g., non-nanoparticulate silica).

The amount of the filler used in the present animal litter composition can vary. In some embodiments, filler may be expressly excluded (i.e., forming 0% of the litter composition). Preferably, the filler provides the balance of the animal litter composition after all other materials are included. As examples, the animal litter composition can comprise about 0% by weight to about 75% by weight, about 1% by weight to about 50% by weight, about 2% by weight to about 40% by weight, or about 3% by weight to about 20% by weight of the filler based on the total weight of the animal litter composition.

In one or more embodiments, for example, an additive material may include one or more clump aid, or clump enhancing material. Description of suitable clump aids is provided in U.S. Pat. No. 8,720,375 to Miller et al., the disclosure of which is incorporated herein by reference. Useful clump aids are those materials suitable to promote adhesion of the fine size particles of litter granules to each other as well as adhesion of the particles to form agglomerates when wetted. Preferably, the clump aid allows the formation of a gelled agglomerate when exposed to a liquid, such as animal urine. A clump aid may be provided in admixture (e.g., in particle form) with the further materials forming the animal litter. In some embodiments, the clump aid can be provided as a coating on at least a portion of the other particles forming the animal litter (e.g., as a coating on at least a portion of the zeolite-based liquid adsorbing material). Such coatings may be provided by any known method, such as spraying.

Non-limiting examples of materials suitable for use as a clump aid include naturally occurring polymers (e.g., naturally occurring starches, water soluble polysaccharides, and gums), semisynthetic polymers (e.g., cellulose derivatives, such as carboxymethyl cellulose), and sealants. Exemplary clump aids include amylopectins, natural gums (e.g., guar gum), and sodium carboxymethylcellulose. The amount of any clump aid that is present in the animal litter composition can vary based upon the total composition. In some embodiments, a clump aid can be present in a total amount of 0.1% by weight to about 6% by weight, about 0.2% by weight to about 5.5% by weight, about 0.3% by weight to about 5% by weight, or about 0.5% by weight to about 4% by weight.

In addition to the foregoing, one or more further materials may be included in the present animal litter composition. Specifically, any conventional litter additive may be included to the extent that there is no interference with the ability of the litter composition to provide the useful effect of reduced dusting. Non-limiting examples of additional additive materials that may be used include binders, preservatives, such as biocides (e.g., benzisothiazolinone, methylisothiazolone), fragrances, bicarbonates, and combinations thereof. Each of the foregoing materials separately may be included in any amount up to about 6% by weight, up to about 2% by weight, up to about 1% by weight, or up to about 0.5% by weight, such as about 0.01% by weight to about 5% by weight, to about 4% by weight, to about 3% by weight, to about 2% by weight, or to about 1% by weight based on the total weight of the animal litter composition. Further, it is understood that any one or more of such materials may be expressly excluded from the present animal litter composition.

The animal litter compositions as described herein may be prepared by a variety of processes. In some embodiments, a method for producing an animal litter composition can comprise providing a plurality of particles of diatomaceous earth and mixing the plurality of particles of diatomaceous earth with the PVOH and the nanoparticulate silica. For such mixing, the diatomaceous earth can be provided in a substantially dry state (e.g., having less than 5%, less than 2%, less than 1%, or less than 0.5% moisture content by weight of the total diatomaceous earth product). The PVOH and/or the nanoparticulate silica can independently be added in a flowable form. For example, the nanoparticulate silica may be conveniently added as an aqueous dispersion of nanoparticulate colloidal silica; however, other forms of nanoparticulate silica dispersed in an aqueous medium may be also be used. As another example, the PVOH may be provided as an aqueous solution. Mixing can be of sufficient energy to form a simple mixture of the components. In some embodiments, mixing can be sufficient to provide one or both of the PVOH and the nanoparticulate colloidal silica as a coating on at least a portion of an outer surface of the plurality of particles of the diatomaceous earth. In some embodiments, at least a portion of the PVOH may become coated onto the outer surface of the particles of the diatomaceous earth while the nanoparticulate silica remains in admixture and/or becomes embedded in the PVOH coated on the particles of the diatomaceous earth.

Preferably the diatomaceous earth, PVOH, and nanoparticulate silica are mixed until the liquid components have been absorbed into the diatomaceous earth by visual inspection. For example, after a suitable duration of mixing, the diatomaceous earth will visually appear to be substantially thy, which indicates that the aqueous components from the PVOH and nanoparticulate silica materials have been absorbed, and the dry components from the PVOH and the nanoparticulate silica have been suitably mixed with the diatomaceous earth. Although the mixture can appear dry by visual inspection, in some embodiments it can be useful to further dry the mixture to remove the aqueous media from the original PVOH and nanoparticulate silica materials. For example, the mixture may be dried at a temperature of about 40° C. to about 90° C., about 45° C. to about 80° C., or about 50° C. to about 70° C. for a time of about 30 minutes to about 24 hours, about 1 hour to about 18 hours, or about 2 hours to about 12 hours.

The animal litter composition formulated as described herein preferably provides enhanced dust reduction properties. The ability of the present compositions to provide dust reduction is further illustrated in the Examples provided below. The animal litter compositions described herein may be used for a wide variety of animals and birds, e.g., uncaged household pets, such as cats and dogs, particularly puppies too young to be walked; caged pets, such as hamsters, gerbils and rabbits; caged laboratory animals, such as guinea pigs, mice, rats and monkeys; animals raised for fur, such as mink; barnyard birds, such as chickens, ducks and geese; and pet birds, such as parrots, parakeets, canaries and pigeons. The compositions of this invention are particularly suitable for use as cat litters.

### Example 1

Several dust-reducing compositions were prepared for application to diatomaceous earth to form sample animal litter compositions. For each dust-reducing composition, 150 g of liquid was prepared including a sufficient amount of PVOH and nanoparticulate silica (Ludox® CL) to provide the dry weight percentage of the respective components after addition to 400 g of the diatomaceous earth by direct mixing in a mixer. The diatomaceous earth particles had an average particle size range of about 0.50 mm to about 1.18 mm—i.e., a material that passed through an ANSI sieve size of 16 but was retained on a number 36 sieve. Following application of the liquid composition to the diatomaceous earth, all samples appeared dry to the touch, indicating that the water medium was absorbed by the diatomaceous earth. Nevertheless, all samples were dried in a 60° C. oven overnight in order to simulate extensive moisture loss. The various combinations of PVOH and nanoparticulate silica utilized in forming the twenty samples are shown in Table 1 below.

TABLE 1

| | PVOH (Active basis, | Nanosilica (Active | Wt. % | Wt. % |
|---|---|---|---|---|
| | wt. %) in liquid | basis, wt. %) in | PVOH | Nanosilica |
| Sample | applied to DE | liquid applied to DE | dry | dry |
| 1 | 0 | 0 | 0.00 | 0.00 |
| 2 | 1 | 0 | 0.37 | 0.00 |
| 3 | 3 | 0 | 1.11 | 0.00 |
| 4 | 5 | 0 | 1.84 | 0.00 |
| 5 | 10 | 0 | 3.61 | 0.00 |
| 6 | 0 | 1 | 0.00 | 0.37 |
| 7 | 1 | 1 | 0.37 | 0.37 |
| 8 | 3 | 1 | 1.11 | 0.37 |
| 9 | 5 | 1 | 1.83 | 0.37 |
| 10 | 10 | 1 | 3.60 | 0.36 |
| 11 | 0 | 5 | 0.00 | 1.84 |
| 12 | 1 | 5 | 0.37 | 1.83 |
| 13 | 3 | 5 | 1.09 | 1.82 |
| 14 | 5 | 5 | 1.81 | 1.81 |
| 15 | 10 | 5 | 3.55 | 1.78 |
| 16 | 0 | 10 | 0.00 | 3.61 |
| 17 | 1 | 10 | 0.36 | 3.60 |
| 18 | 3 | 10 | 1.07 | 3.58 |
| 19 | 5 | 10 | 1.78 | 3.55 |
| 20 | 10 | 10 | 3.49 | 3.49 |

### Example 2

The animal litter compositions prepared according to Example 1 were evaluated for dust generation by pouring 100 mL of each litter composition from the top of a 500 mL graduated cylinder. Dust present at the top of the graduated cylinder was monitored using a Fluke 985 particle counter over a sampling time of 1 minute and a total collection volume of 2.8 L. The collection tube, which extended from the top of the graduated cylinder into the vessel a depth of about 0.75 inches, positioned extended through a plastic lid. The top of the tube was not completely sealed so as to allow air to move into the tube (i.e., at the spout of the graduated cylinder) during the sampling period.

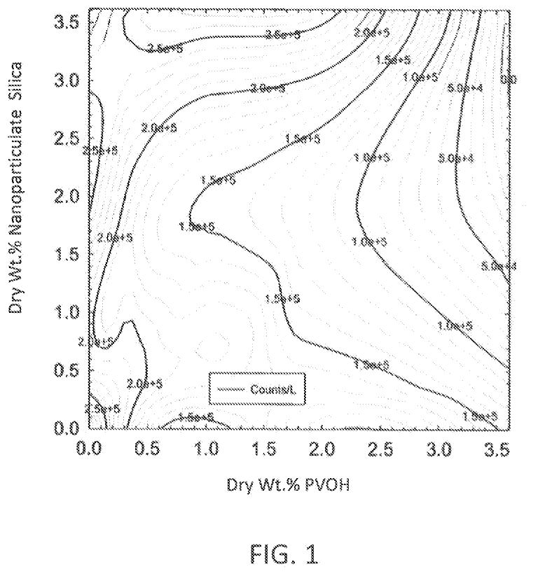

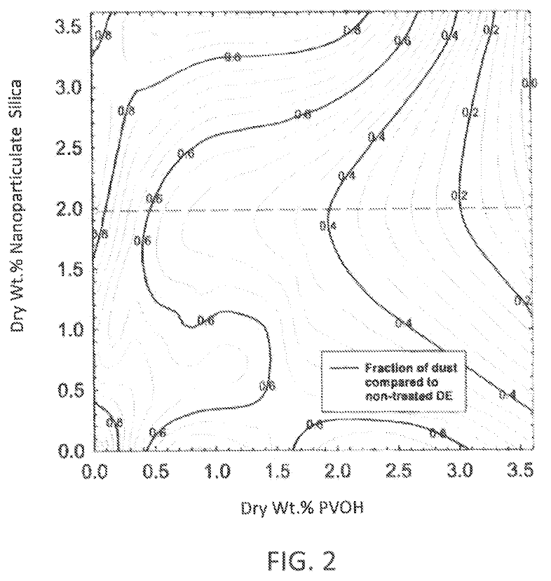

The sample data was used to generate the contour plot provided in FIG. 1, which shows total particle counts for particles ≥0.5 μm in diameter. The percentage of nanoparticulate silica (y-axis) and percentage of PVOH (x-axis) represent levels applied to the diatomaceous earth on a dry basis. The “bulge” in the contours in the mid-section of the plot shows that there was an optimum region for dust suppression. It was also useful to examine the data in terms of the fraction of dust generated in relation to the amount of dust generated at 0 wt. % PVOH and 0 wt. % nanoparticulate silica—i.e., treatment with water only. This is illustrated in the contour plot shown in FIG. 2. As can be seen from the contour plots, at about 2 wt. % nanoparticulate silica, application of the PVOH was most effective in mitigating dusting during pouring of the litter composition.

The data from Table 1 is provided again in Table 2 below showing the levels of dust measured for the various treatments. The dust levels are provided in terms of total particle counts for particles above 0.5 μm in diameter, normalized to dust counts for non-treated diatomaceous earth. All percentages are on a dry basis.

TABLE 2

| | Wt. % | Wt. % | Ratio | Fraction of |
|---|---|---|---|---|
| | PVOH | Nanosilica | PVOH to | Diatomaceous |
| Sample | dry | dry | Nanosilica | earth alone |
| 1 | 0.00 | 0.00 | | 1.00 |
| 2 | 0.37 | 0.00 | | 0.638 |
| 3 | 1.11 | 0.00 | | 0.491 |
| 4 | 1.84 | 0.00 | | 0.644 |
| 5 | 3.61 | 0.00 | | 0.491 |
| 6 | 0.00 | 0.37 | 0.00 | 0.810 |
| 7 | 0.37 | 0.37 | 1.00 | 0.706 |
| 8 | 1.11 | 0.37 | 3.00 | 0.606 |
| 9 | 1.83 | 0.37 | 5.00 | 0.573 |
| 10 | 3.60 | 0.36 | 10.00 | 0.388 |
| 11 | 0.00 | 1.84 | 0.00 | 0.846 |
| 12 | 0.37 | 1.83 | 0.20 | 0.421 |
| 13 | 1.09 | 1.82 | 0.60 | 0.498 |
| 14 | 1.81 | 1.81 | 1.00 | 0.421 |
| 15 | 3.55 | 1.78 | 2.00 | 0.111 |
| 16 | 0.00 | 3.61 | 0.00 | 0.745 |
| 17 | 0.36 | 3.60 | 0.10 | 0.869 |
| 18 | 1.07 | 3.58 | 0.30 | 0.916 |
| 19 | 1.78 | 3.55 | 0.50 | 0.905 |
| 20 | 3.49 | 3.49 | 1.00 | 0.081 |

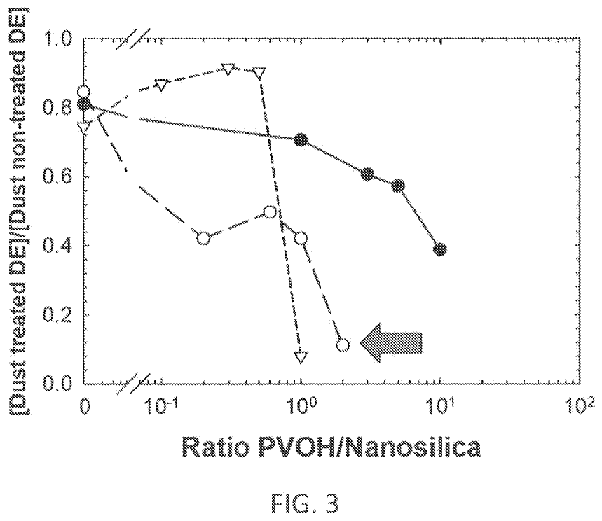

The data from Table 2 is further illustrated in FIG. 3 where it is plotted as the dust fraction versus the ratio of PVOH to nanosilica. The plot utilizes three concentrations of nanosilica: solid line with solid circle=a nanosilica concentration of 0.37 wt. %; open circle with long dashed line=a nanosilica concentration of 1.8 wt. %; and open triangle with short dashed line=nanosilica concentration of 3.55 wt. %.

At the lowest nanosilica concentration (0.37 wt. %), adding PVOH gradually reduced the dust level, but at a nanosilica concentration of 1.8 wt. %, adding PVOH significantly reduced the dust at about a 2/1 ratio of PVOH to nanosilica. At a nanosilica concentration of 3.55 wt. %, adding about a 1/1 ratio of PVOH to nanosilica significantly reduced the dust level. It is further noted that the high level of nanosilica (3.55 wt. %) actually increased the level of dust until a critical level of PVOH was added. The data point highlighted by the arrow in FIG. 3 is the same as sample 15 from Table 1 and Table 2. As will be described below, this sample also exhibited a low opacity.

### Example 3

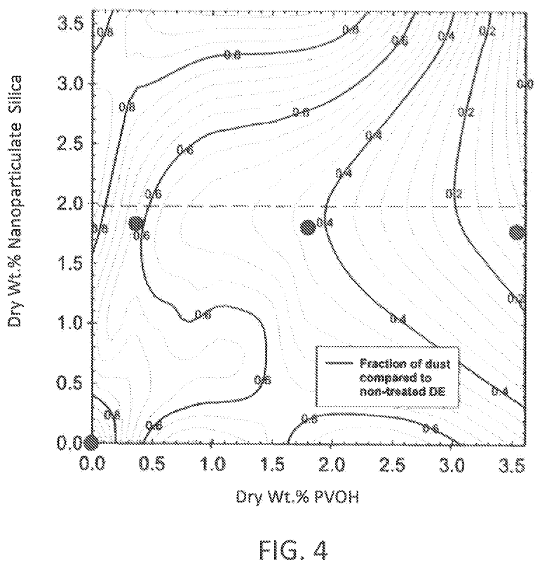

Four samples (1, 12, 14, and 15) were chosen from the formulation space of the contour plot described in Example 2 to sample via an opacity measurement. In this measurement, 500 mL of each litter composition was dropped from the top of an acrylic tube (24 inches tall by 5.25 inches in diameter). The dust at 30 seconds following the drop was monitored via an opacity meter (6500 Smoke Meter available from Robert H. Wager Co.), which was used to monitor the dust cloud formed. The compositions of the samples used are shown by the dots in the contour plot shown in FIG. 4. The average opacity readings for the samples are shown in Table 3 below. As can be seen, a significant decrease in the amount of dusting was observed with composition 15.

TABLE 3

| | | Wt. % | | |
|---|---|---|---|---|
| | Wt. % | Nanoparticulate | | |
| Sample | PVOH dry | silica dry | Opacity % | Opacity error |
| 1 | 0.00 | 0.00 | 28.4 | 2.5 |
| 12 | 0.37 | 1.83 | 24.7 | 2.8 |
| 14 | 1.81 | 1.81 | 21.1 | 1.9 |
| 15 | 3.55 | 1.78 | 3.9 | 1.1 |

Many modifications and other embodiments of the disclosure set forth herein will come to mind to one skilled in the art to which these disclosure pertain having the benefit of the teachings presented in the foregoing descriptions. Therefore, it is to be understood that the disclosure is not to be limited to the specific embodiments disclosed and that modifications and other embodiments are intended to be included within the scope of the appended claims Although specific terms are employed herein, they are used in a generic and descriptive sense only and not for purposes of limitation.

1. An animal litter composition comprising:
a plurality of particles of diatomaceous earth;
polyvinyl alcohol (PVOH); and
a nanoparticulate silica material.

2. The animal litter composition of claim 1, wherein the plurality of particles of the diatomaceous earth have an average particle size of about 0.2 mm to about 5 mm.

3. The animal litter composition of claim 1, wherein the PVOH has a degree of hydrolysis of about 87% to about 89%.

4. The animal litter composition of claim 1, wherein the PVOH has a weight average molecular weight of about 20,000 g/mol or greater.

5. The animal litter composition of claim 1, wherein the PVOH has a weight average molecular weight of about 20,000 g/mol to about 75,000 g/mol.

6. The animal litter composition of claim 1, wherein the nanoparticulate silica has an average particle size of about 50 nm or less.

7. The animal litter composition of claim 1, wherein the nanoparticulate silica has an average particle size of about 5 nm to about 25 nm.

8. The animal litter composition of claim 1, wherein the nanoparticulate silica is cationic.

9. The animal litter composition of claim 1, wherein the nanoparticulate silica is a colloidal silica.

10. The animal litter composition of claim 1, wherein one or both of the PVOH and the nanoparticulate silica material is present as a coating on at least a portion of an outer surface of the plurality of particles of the diatomaceous earth.

11. The animal litter composition of claim 1, wherein the PVOH is present in an amount of about 0.5% to about 5% by weight based on the total weight of the animal litter composition.

12. The animal litter composition of claim 1, wherein the nanoparticulate silica is present in an amount of about 0.5% to about 5% by weight based on the total weight of the animal litter composition

13. A method for producing an animal litter composition, the method comprising:
providing a plurality of particles of diatomaceous earth;
mixing the plurality of particles of diatomaceous earth with an aqueous dispersion of nanoparticulate colloidal silica and an aqueous solution of polyvinyl alcohol (PVOH) to form a mixture; and
drying the mixture to form the animal litter composition.

14. The method of claim 13, wherein the plurality of particles of the diatomaceous earth have an average particle size of about 0.2 mm to about 5 mm.

15. The method of claim 13, wherein the PVOH has a degree of hydrolysis of about 80% to about 99% and a weight average molecular weight of about 20,000 g/mol to about 75,000 g/mol.

16. The method of claim 13, wherein the nanoparticulate silica has an average particle size of about 5 nm to about 25 nm.

17. The method of claim 13, wherein the nanoparticulate colloidal silica is cationic.

18. The method of claim 13, wherein said mixing is effective to provide one or both of the PVOH and the nanoparticulate colloidal silica as a coating on at least a portion of an outer surface of the plurality of particles of the diatomaceous earth.

19. The method of claim 13, wherein the plurality of particles of the diatomaceous earth is mixed with a sufficient amount of the aqueous solution of the PVOH such that the resulting animal litter composition comprises about 0.5% to about 5% by weight of the PVOH based on the total weight of the animal litter composition.

20. The method of claim 13, wherein the plurality of particles of the diatomaceous earth is mixed with a sufficient amount of the aqueous dispersion of the nanoparticulate colloidal silica such that the resulting animal litter composition comprises about 0.5% to about 5% by weight of the nanoparticulate colloidal silica based on the total weight of the animal litter composition.
